(19) United States
(12) Patent Application Publication
(10) Pub. No.: US 2008/0009318 A1
(43) Pub. Date: Jan. 10, 2008

(54) CONFIGURATION OF REMOTE DEVICES

(76) Inventor: David William Evans, Berkshire (GB)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/768,515

(22) Filed: Jun. 26, 2007

(30) Foreign Application Priority Data
Jun. 26, 2006 (GB) 0612628.8

(51) Int. Cl. H04B 1/38

(52) U.S. Cl. 455/558

(57) ABSTRACT

A communications system is provided comprising a remote device such as a mobile cellular phone, a communications network and a server. Provided on the remote device is a control module which is arranged to detect the availability of a new communications network when for example a SIM card is inserted into the remote device. If the control module detects that a new communications network is available the control module causes the remote device to connect to a server and transmit to the server data identifying the new communications network. The server then proceeds to select and transmit back to the remote device content data on the basis of the identity of the communications network. The content data is then utilised to configure the remote device so that the remote device is appropriately configured to interact with the newly available communications network.

### CROSS-REFERENCE TO RELATED APPLICATION

This application claims the benefit of priority of Great Britain Patent Application No. 0612628.8, filed Jun. 26, 2006. The entire disclosure of Great Britain Patent Application No. 0612628.8 is hereby incorporated by reference herein.

### FIELD OF THE INVENTION

The present application relates to the configuration of remote devices. More specifically embodiments of the present invention relate to configuration of remote devices such as mobile cellular phones.

### BACKGROUND OF THE INVENTION

An operator can customise a number of features of a mobile cellular phone. Typical items that are customised by an operator include application configuration e.g. GPRS, SMS and MMS settings, custom applications, MMI colour schemes, themes, wallpapers and ring tones, soft keys, hard keys, stored device menus, WAP homepages, embedded links within ring tones, games and wallpaper device menus and the locking of a device to a user's network. The mobile device value chain from device vendor through to distributor to operator and final subscriber is therefore a complex chain, consisting of consumer electronics design, manufacture, and software customisation and delivery.

Conventionally such customisation of a mobile cellular phone is formed prior to a device being shipped. If a subscriber later changes operator certain customisations will continue to be active although such services are no longer available. Further because the customisations are performed prior to delivery, customisation can not be changed once a device is shipped resulting in an operator having to continue services for long periods to support legacy handsets. Further inclusion of a customisation step prior to shipping complicates testing and raises device manufacturing costs. A more flexible approach is therefore desirable.

### SUMMARY OF THE INVENTION

In accordance with one aspect of the present invention there is provided a method of method of downloading content from a server onto a remote device in accordance with claim 1.

In accordance with another aspect of the present invention there is provided a remote device in accordance with claim 6.

In accordance with a further aspect of the present invention there is provided a computer readable medium in accordance with claim 12.

### BRIEF DESCRIPTION OF THE FIGURES

Further aspects and embodiments of the present invention will become apparent with reference to the following description and accompanying drawings in which:

FIG. 1 is a schematic block diagram of a communications system embodying the present invention;

FIG. 2 is a flow diagram of the processing performed by the control module of the remote device of the communication system of FIG. 1; and

FIG. 3 is a flow diagram of the processing of an update control module of the server of the communications system of FIG. 1.

### DETAILED DESCRIPTION OF THE INVENTION

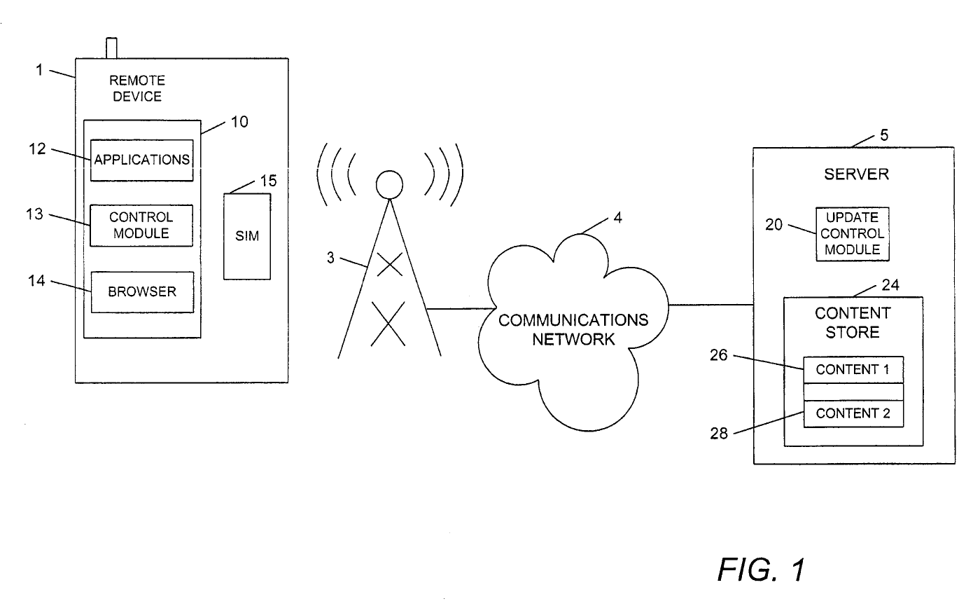

Referring to FIG. 1, a communications system is provided comprising a remote device 1 such as a mobile cellular phone which can be connected via a communications network 3,4 to a server 5. Typically a communications network 3,4 will comprise a radio portion 3 and a landline portion 4.

In this embodiment the remote device has a memory 10 within which are stored a number of application programs 12, a control module 13 and a browser program 14. The browser program 14 is a program that is arranged to co-ordinate the functioning of the remote device when the remote device excesses remotely stored data on the server 5 via the communications network 3,4.

Also provided as part of the remote device 1 is a SIM card 15. The SIM card 15 is a removable storage device which stores identification data which enables a communications network operator to uniquely identify an individual remote device 1 and thereby log and monitor the extent to which a remote device 1 utilises the communications network 3,4. The SIM card 15 also provides means by which the remote device 1 can identify itself to the communications network and thereby establish a communications link from the remote device to another user of the communications network.

Provided on the server 5 is an update control module 20 and a content store 24 which is configured to store a number of different items of content 26,28.

In accordance with an embodiment of the present invention the control module 13 of the remote device 1 is configured to monitor whether a SIM card 15 inserted into the remote device 1.

When the control module 13 identifies that a SIM card 15 has been inserted into the remote device 1 the control module 13 then determines whether the SIM card 15 enables the remote device 1 to access a different communications network 3,4 to a network previously used. If this is the case the control module 13 then invokes the browser 14 to cause the browser 14 to connect to the server 5 via the newly available communications network 3,4.

When a communications link is established between the remote device 1 and the server 5, the browser 14 then transmits to the server 5 via the communications link details of the communications network 3,4 through which the communications link has been established.

When the update control module 20 of the server 5 receives this data, the update control module 20 extracts content 26,28 from the content store 24 which is selected on the basis of the identity of the network through which the communications link has been established. This content is then transmitted back via the established communications link to configure the application programs 12 of the remote device 1 so that the applications 12 are customised appropriately for the communications network that the SIM 15 enables the remote device 1 to interact with.

By having the control module 13 detect when the insertion of a SIM card 15 enables the remote device 1 to connect to other devices via a different communications network, the control module 13 is able to cause the remote device 1 to become configured appropriately for the communications networks which it actually may interact with. As the applications 12 do not need to be preconfigured the problems arising due to old or out-of-date or inappropriate applications do not arise.

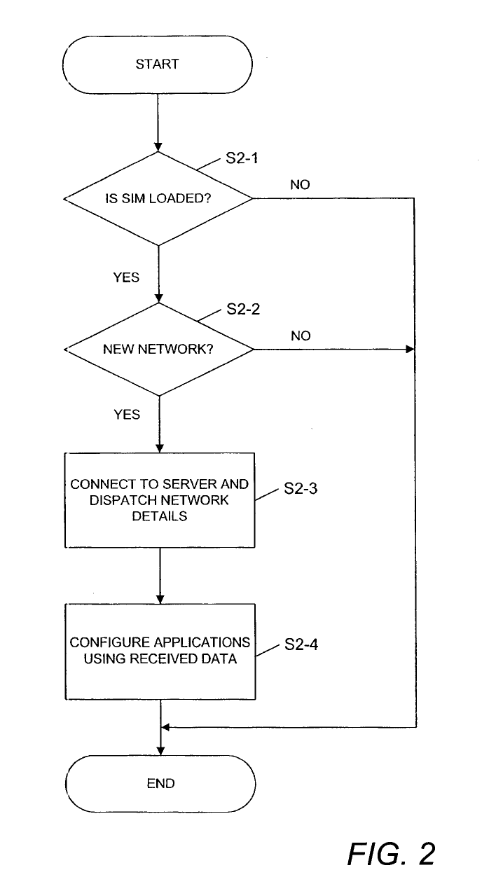

The functioning of the control module 13 will now be described in greater detail with reference to FIG. 2 which is a flow diagram of the processing undertaken by the control module 13 of the remote device 1. When the remote device 1 is activated the control module 13 initially (S2-1) determines whether a SIM card 15 has been loaded into the remote device 1. If no SIM card is present the processing of the control module 13 ends.

Alternatively if the control module 13 detects that a SIM card 15 has been inserted into the remote device one, the control module then (S2-2) utilises data stored within the SIM card 15 to determine what communications network 3,4 the SIM card 15 enables the remote device to interact with and whether that communications network 3,4 corresponds to a communications network 3,4 the remote device 1 has previously interacted with.

In this embodiment this is achieved by the control module 13 storing data identifying the communications network 3,4 that the remote device 1 previously has utilised to connect to any other remote devices or servers. If the control module 13 determines that the SIM card 15 enables the remote device 1 to connect to other devices via a communications network 3,4 other than the network identified by previously stored data or alternatively the control module 13 has no data stored identified a previously utilised communications network, this indicates to the communications module 13 that the insertion of the SIM card 15 enables the remote device 1 to communicate via a new network.

If the communications module 13 determines that the communications network that the SIM 15 which is inserted in the remote device 1 is arranged to utilise the communications network which has previously been utilised the processing of the control module 13 ends.

If, however, the control module 13 is able to determine that the SIM card 15 inserted into the remote device 1 causes the remote device 1 to be able to utilise a new communications network, the control module 13 then (S2-3) activates the browser 14 and causes the browser 14 to generate a communications link via the new available communications network 3,4 to the server 5. When a communications link is established between the remote device 1 and the server 5, the browser 14 then dispatches data via the communications link to the server which identifies to the server 5 the network 3,4 being utilised for the established communications link.

After having dispatched details of the network 3,4 which the SIM card 15 enables the remote device 1 to utilise to access other devices, the control module 13 then waits for data to be received from the server 5 which will comprise content data 26,28 selected from the contents store 24 of the server 5. When this content data 26,28 is received the control module 13 then (S2-4) utilises the received content data to configure the application programs 12 stored within the memory so that the application programs are customised in a manner appropriate to the communications network that the remote device one is able to interact with.

Typical configuration data might be application configuration such as GPRS, SMS or MMS settings, MMI colour schemes, themes, wallpapers or ring tones, soft keys, hard keys, a main menu for the remote device, a WAP homepage link and embedded links within ring tones, games, wallpaper device menus etc. Thus in this way by having the control module 13 determine when a new network is available and then causing the browser program 14 to request and obtain an update based on the newly available network the remote device 1 can be configured in such a way so as to ensure that the applications 12 available on the remote device 1 correspond to the applications which will be utilised with the newly available network 3,4.

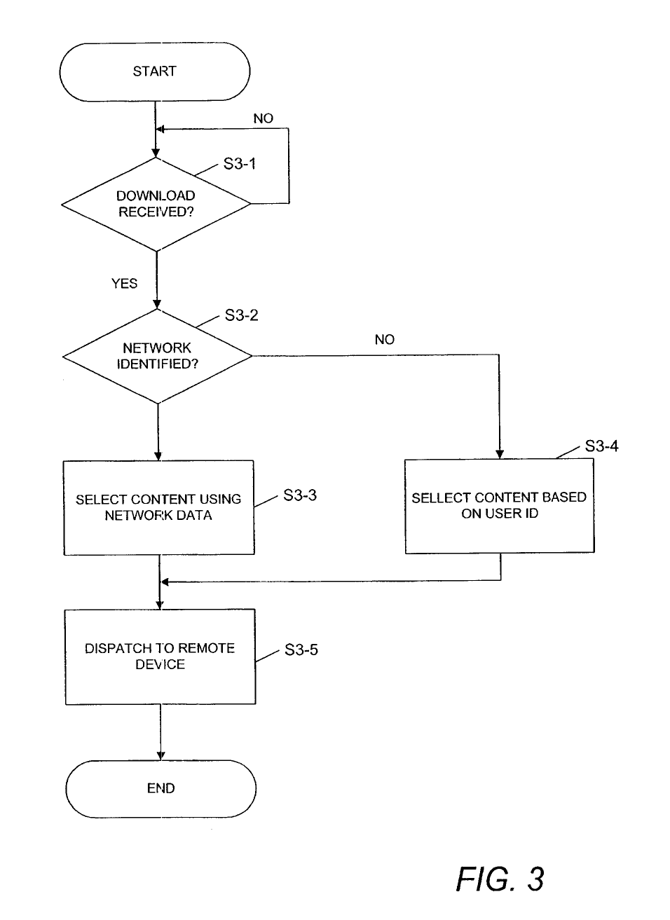

FIG. 3 is a flow diagram of the processing undertaking by the update control module 20 of a server 5 in accordance with an embodiment of the present invention. When the update control module 20 is activated, the update control module 20 initially (S3-1) waits until a download request is received from a communications network 4. When a download request is received, the update control module 20 then processes the received request to identify whether the received request is a request which includes data identifying a newly available communications network that a remote device 1 is able to interact with.

If the update control module 20 determines (S3-2) that a received download request is a download request which includes the identification of a newly available network, the update control module 20 then (S3-3) proceeds to select content 26,28 stored within the content store 24 of the server 5 on the basis of the received identification of a newly available network. Thus by having different content stored within the content store 24 for different network providers, by selecting content on the basis of the availability of a communications network to be accessed by the remote device, the update control module is able to select appropriate content for customising a remote device 1 to utilise a particular network.

In contrast, if the update control module 20 determines that a download request does not include an identification of the network a remote device is newly available to access the update control module 20 then (S3-4) proceeds to select content from the content store 24 on the basis of another selection criteria such as for example a user identification for the remote device.

After content 26,28 from the content store 24 has been selected the update control module 20 then (S3-5) proceeds to cause the content to be transmitted back via the communications network and radio link 3,4 to the remote device 1 making the initial download request.

### OTHER MODIFICATIONS AND EMBODIMENTS

Although in the above described embodiment a remote device 1 has been described as storing an initial set of applications 12 within its memory 10 it will be appreciated that the content 26,28 within the content store 24 could itself comprise application programs rather than just configuration data and that the insertion of a SIM 15 enabling a remote device to access a new communications network could be utilised to initiate the storage of new applications 12 within the memory of the remote device 1.

Further it will also be appreciated that although the above description refers to detecting the availability of a new communications network, the above described invention is equally applicable to reconfigure a remote device when a user returns to using earlier communications network after being configured to utilise another network.

It will be appreciated that when referring to identifying a communications network 3,4 to a server 5 any suitable data identifying for example a network service provider or a service type which a SIM 15 enables could be utilised to select content for customisation of a remote device 1.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source or object code or in any other form suitable for use in the implementation of the processes according to the invention. The carrier can be any entity or device capable of carrying the program.

For example, the carrier may comprise a storage medium, such as a ROM, for example a CD ROM or a semiconductor ROM, or a magnetic recording medium, for example a floppy disc or hard disk. Further, the carrier may be a transmissible carrier such as an electrical or optical signal which may be conveyed via electrical or optical cable or by radio or other means.

When a program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

1. A method of downloading content from a server onto a remote device comprising:
detecting the loading of a SIM card into the remote device;
interrogating the SIM card to determine that a communications network is available to the remote device;
responding to the determination that a communications network not previously available to the remote device can be utilised by generating a communications link via the communications network to the server;
transmitting from the remote device to the server via the communications link data identifying the communications network determined to be available to the remote device;
selecting data stored on the server to be transmitted to the remote device on the basis of the data identifying the communications network determined to be available to the remote device; and
transmitting the selected data to the remote device via the communications link.

2. The method of claim 1 wherein determining that a communications network is available to the remote device further comprises:
determining whether a communications network available to the remote device corresponds to a communications network previously utilised by the remote device.

3. The method of claim 1, wherein the data stored on the server comprises data for configuring remote devices, the method further comprising configuring the remote device utilising the selected data transmitted via the communications link.

4. The method of claim 1, wherein the remote device comprises a cellular mobile phone and the communications network comprises a cellular mobile phone network.

5. The method of claim 3 wherein the data stored on the server comprises data for configuring a remote device selected from: data for configuring GPRS settings, SMS settings, MMS settings, MMI colour schemes, themes, wallpaper, ring tones, soft key configurations, hard key configurations, menu settings, and home page links for a remote device.

6. A remote device comprising:
a detector operable to:
detect the loading of a SIM card into the remote device; and
interrogate the SIM card to determine that a communications network is available to the remote device;
a control module responsive to the detection of the availability for use by the remote device of a communications network not previously available to the remote device by the detector to generate a communications link via the available communications network to a server and to transmit from the remote device to the server via the communications link data identifying the communications network determined to be available to the remote device; and
a configuration module operable to configure the remote device on the basis of data received from the server via a generated communications link in response to transmission of data identifying a communications network.

7. The remote device of claim 6 wherein the detector is further operable to:
determine whether a communications network available to the remote device corresponds to a communications network previously utilised by the remote device.

8. The remote device of claim 6 wherein the remote device comprises a cellular mobile phone and the communications network comprises a cellular mobile phone network.

9. A communications system comprising:
a remote device remote device comprising:
a detector operable to:
detect the loading of a SIM card into the remote device; and
interrogate the SIM card to determine that a communications network is available to the remote device;
a control module responsive to the detection of the availability for use by the remote device of a communications network not previously available to the remote device by the detector to generate a communications link via the available communications network to a server and to transmit from the remote device to the server via the communications link data identifying the communications network determined to be available to the remote device; and
a configuration module operable to configure the remote device on the basis of data received from the server via a generated communications link in response to transmission of data identifying a communications network;
a server comprising:
a receiver operable to receive down load requests from remote devices via communications links wherein the down load requests include data identifying a communications network utilised to establish a communications link between the remote device and the server;
a data store operable to store content for transmission to remote devices in association with data identifying communications networks;
a selection module operable to select data stored on the server to be transmitted to a remote device on the basis of the data identifying a communications network; and
a transmitter operable to transmit the data selected by the selection module to a remote device; and
a communications network operable to establish a communications link between the remote device and the server.

10. The communications system of claim 9 wherein the data stored in the data store of the server comprises data for configuring remote devices.

11. The communications system of claim 10 wherein the data stored in the data store of the server comprises data for configuring at least one of: GPRS settings, SMS settings, MMS settings, MMI colour schemes, themes, wallpaper, ring tones, soft key configurations, hard key configurations, menu settings, and home page links for a remote device.

12. A computer readable medium operable storing computer implementable instructions which when implemented by a programmable remote device cause the remote device to:
detect the loading of a SIM card into the remote device;
interrogate the loaded SIM card to determine that a communications network is available to the remote device;
respond to the determination that a communications network not previously available to the remote device can be utilised by generating a communications link via a communications network to a server;
transmit from the remote device to the server via the communications link data identifying the communications network determined to be available to the remote device; and
configuring the remote device utilising selected data transmitted via the communications link, selected on the basis of the data identifying the communications network determined to be available to the remote device transmitted by the remote device.

13. The computer readable medium of claim 12 wherein the instructions for determining that a communications network is available to the remote device comprise instructions which cause the device to:
determine whether a communications network available to the remote device corresponds to a communications network previously utilised by the remote device.

14. The computer readable medium of claim 12 wherein the remote device comprises a cellular mobile phone and the communications network comprises a cellular mobile phone network.

15. The computer readable medium of claim 14 wherein the data stored on the server comprises data for configuring a remote device selected from: data for configuring GPRS settings, SMS settings, MMS settings, MMI colour schemes, themes, wallpaper, ring tones, soft key configurations, hard key configurations, menu settings, and home page links for a remote device.

16. The computer readable medium of claim 12 comprising an electrical signal in a communications network.

17. The computer readable medium of claim 12 comprising a computer disc.

18. The computer disc of claim 17 comprising an optical, magnetic or magneto-optical disc.

19. The computer readable medium readable medium of claim 12 comprising a SIM card.
